(19) United States
(12) Patent Application Publication
(10) Pub. No.: US 2010/0000803 A1
(43) Pub. Date: Jan. 7, 2010

(54) CAPACITIVE TOUCH PANEL WITH X AND Y AXIS TRACES

(76) Inventor: Kai-Ti Yang, Taoyuan (TW)

Correspondence Address: Kai-Ti Yang, 235 Chung - Ho Box 8-24, Taipei, TW

(21) Appl. No.: 12/168,063

(22) Filed: Jul. 3, 2008

(51) Int. Cl. G06F 3/044

(52) U.S. Cl. 178/18.06

(57) ABSTRACT

A capacitive touch panel is made of transparent panel assembled by a substrate layer, a sensing layer, an insulated layer, and a surface layer. A plurality of transparent X and Y axis traces are arranged on the same plane of the sensing layer and the X and Y axis traces intersect each other as a matrix. Induction-spots formed on each X axis trace are connected one by one, while the induction-spots of each Y axis trace are formed separately with gaps. Through holes in pair are formed on the insulated layer respectively to all the abreast induction-spots of each Y axis trace. A conductive wire is arranged above and across the pair of through holes. Both ends of the conductive wire exposed to the through holes respectively are formed as electrical joints. While the insulated layer is arranged above the sensing layer.

### FIELD OF THE PRESENT INVENTION

The present invention relates to touch panels, and particular to a capacitive touch panel with X and Y axis traces formed on the same plane.

### DESCRIPTION OF THE PRIOR ART

A prior capacitive touch panel structure includes an X axis sensing layer and a Y axis sensing layer and both of it are arranged inside the touch panel and insulated from each other. The X and Y sensing layers are grounded and connected to a control circuit respectively. When operating, an instant capacity effect is generated by a conductor or a user's finger touch so as the position being touched will be located by detection of the variation of capacitance. The capacitive touch panel is capable of being operated by human finger, therefore it is convenient for an input operation. The panel will not repeatedly sustain stress and then deformed and damaged because an input is performed without strongly pressing on the panel. Moreover, the assembly of the capacitive touch panel is simple, the components needed are few, and production yield is high, thus it is suitable for mass production to lower the cost. However, in the prior capacitive touch panel, the X and Y axis sensing traces are formed on two different layers. When assembling the X and Y sensing traces of the two different layers, a misalignment is happened and the sensitivity and precision of the sensing signal of the capacity will be damaged. However, the traces and the un-patterned area on different layers are differently pervious to light, the light passing through the panel will be refracted and causes a deformation and distortion of image displayed from the screen under the touch panel.

### SUMMARY OF THE PRESENT INVENTION

Accordingly, the present invention provides a touch panel structure with the X and Y axis traces in a same plane so as the traces can be formed more precisely to improve the sensitivity and the precision of the sensing effect. Moreover, the un-patterned area ratio is substantially reduced so as the panel is uniformly pervious to light and the image distortion of the screen under the touch panel is corrected.

The insulated layer is made of a material of highly transparent insulated thin film with permittivity of 2 to 4, preferably, such as ink or Polythylene terephthalate (PET). The conducting wires are made of a transparent organic conductive film such as PEDOT, or a transparent conductive film such as an Indium Tin Oxide.

The various objects and advantages of the present invention will be more readily understood from the following detailed description when read in conjunction with the appended drawing.

### BRIEF DESCRIPTION OF THE DRAWINGS

FIG. 1 is a prospective view showing the disassembly of the unit of the present invention.

FIG. 2 is a prospective view partially showing a top view of the assembly of an insulated layer and a sensing layer of the present invention.

FIG. 3 is a cross section view along the E-E line of the FIG. 2.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

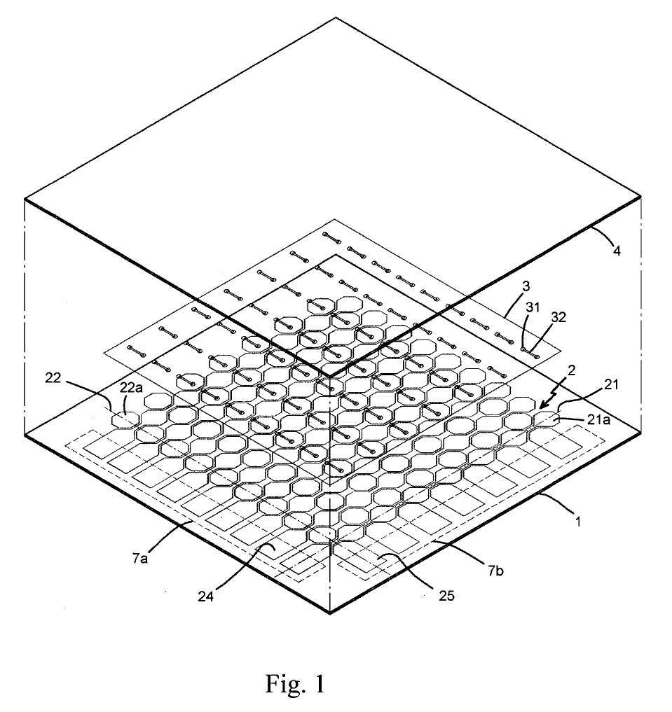

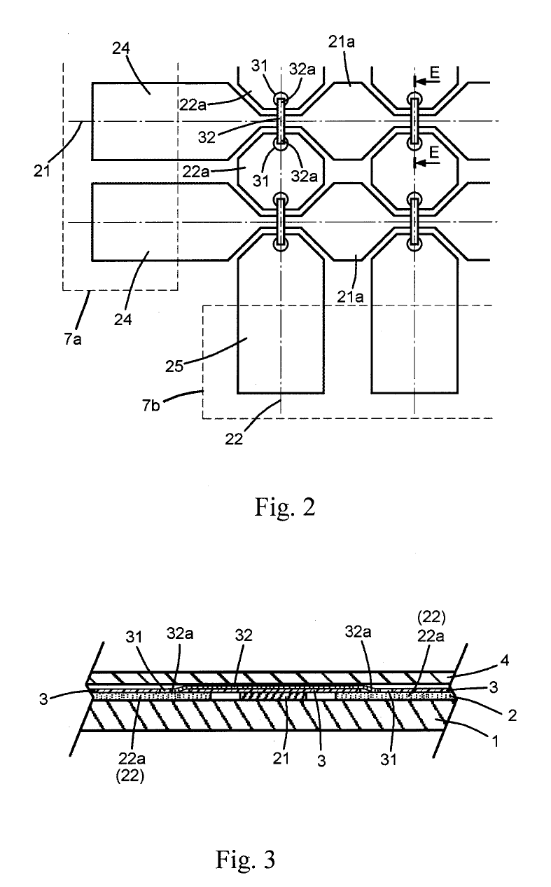

As shown in FIGS. 1 to 3, an embodiment shown in the figures is a capacitive touch panel made of a transparent panel assembled by a substrate layer 1, sensing layer 2, insulated layer 3, and a surface layer 4 in order. The substrate layer 1 and the surface layer 4 are insulated thin panels with highly transparent function such as a thin film material of the glass, Polycarbonate (PC), Polythylene terephthalate (PET), Polymethylmethacrylate (PMMA), or Cyclic Olefin Copolymer. The sensing layer 2 uses a transparent conductive film such as an Indium Tin Oxide, or a transparent organic conductive film such as PEDOT. The sensing layer 2 includes a plurality of transparent X axis traces 21 which are arranged in parallel with fixed interval between, and also includes a plurality of transparent Y axis traces 22 which are arranged in parallel with fixed interval between. The X and Y traces 21, 22 intersect each other as a matrix. Wherein, induction-spots 21a are formed on each X axis trace 21 and are connected one by one, and induction-spots 22a are formed on each Y axis trace but are separately with gaps. The widths of the traces 21 and 22 are usually about 0.05 to 5 mm. An end of each X axis trace 21 is formed a trace joint 24, and an end of each Y axis trace 22 is formed a trace joint 25. The trace joints 24 and 25 can respectively connect to a sliver conducting wire 7a and 7b formed on the panel edges near the trace joints 24 and 25, and then connect to a signal output wire bank (not shown). Through above connections, a sensing signal generated by the X axis traces 21 and Y axis traces 22 on the sensing layer 2 can be transmitted to a succeeding signal processing circuit through the signal output wire bank (not shown).

The insulated layer 3 is made of a material of highly transparent insulated thin film with permittivity of 2 to 4 such as ink or PET mentioned above. Through holes in pair are formed respectively to the abreast induction spots 22a on the insulated layer 3. A conductive wire 32 is arranged on the surface of the insulated layer 3 and crosses between the pair of through holes 31. Both ends of the conductive wire 32 exposed to the through holes 31 respectively are formed as electrical joints 32a. The conductive wire 32 is made of a transparent organic conductive material such as PEDOT. While the insulated layer 3 is arranged above the sensing layer 2, the insulated layer 3 will cover and insulate the X and Y axis traces 21 and 22. Furthermore, the electrical joints 32a on the two ends of the conductive wire 32 will electrical connect the two abreast induction-spots 22a through the through holes 31 respectively so as all the induction-spots 22a of each Y axis trace 22 are connected. That is how the X axis traces 21 and Y axis traces 22 are arranged on the surface of the same sensing layer 2 but independent from each other.

In the above mentioned structure, an equivalent capacity is formed between the X axis trace 21 and the silver conducting wire 7a, and also between the Y axis trace 22 and the silver conducting wire 7b. When a finger or a conductor touches or slide on a certain position on the surface of the touch panel, the signal processing circuit can locate the position by detection of the variation of the capacitance. Therefore, the transparent touch panel of the present invention can be arranged in the front of the screen of an electronic product so as a user can easily perform an input by finger touch under the instruction displayed on the screen. Moreover, the X axis traces and the Y axis traces of the capacitive touch panel of the present invention are arranged precisely because both of those are formed on the same plane. Thus, the sensitivity and the precision of the sensing capacitance are improved. Moreover, in the present invention, the X and Y axis traces 21 and 22 intersect perpendicular to each other and are formed in a same plane of the sensing layer. Therefore, the traces are formed straight and ordered, and the un-patterned area ratio is substantially reduced so as the panel is uniformly pervious to light and the image distortion of the screen under the touch panel is corrected. The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An improved structure of a capacitive touch panel comprising:
a substrate layer of a highly transparent insulated thin layer;
a sensing layer of a transparent thin film with well conductivity having a plurality of X axis trace formed in parallel with a fixed interval and a plurality of Y axis trace formed in parallel with a fixed interval; the X and Y axis traces being formed on the same plane and intersecting each other as a matrix; wherein a plurality of induction-spot formed on each X axis trace are connected one by one and a plurality of induction-spot on each Y axis trace are formed separately with gaps; and a front end of each X trace and each Y trace having a joint;
an insulated layer of an transparent insulated thin film; a plurality of through hole in pairs being formed on the layer corresponding to every two adjacent induction-spots of each Y axis trace; a conducting wire being arranged above and across the pair of the through hole and electrical joints being formed on both ends of the conducting wire exposed to the through holes; and
a surface layer of a transparent insulated plate; while assembling, the layer being arranged above the sensing layer to cover and insulate the X and Y axis traces and the electrical joints on the two ends of the conducting wire passing through the through holes to connect the every two abreast induction-spots of each Y axis trace so as all the induction-spot being connected on each Y axis; each layer mentioned above being glued together as a transparent panel, the front joints of each X and Y axis trace on the sensing layer connecting to a silver conducting wire formed at edges of the panel and conducting to a signal output wire bank; therefore, an output signal of the touch panel being transferred through the signal output wire bank to a succeeding signal processing circuit.
